(19) United States
(12) Patent Application Publication
(10) Pub. No.: US 2009/0025476 A1
(43) Pub. Date: Jan. 29, 2009

(54) METHOD OF BALANCING A VEHICLE WHEEL

(75) Inventor: Francesco BRAGHIROLI, Reggio Emilia (IT)

Correspondence Address: MCDERMOTT WILL & EMERY LLP, 600 13TH STREET, N.W., WASHINGTON, DC, 20005-3096, US

(73) Assignee: SNAP-ON EQUIPMENT SRL A UNICO SOCIO

(21) Appl. No.: 12/179,920

(22) Filed: Jul. 25, 2008

(30) Foreign Application Priority Data
Jul. 27, 2007 (EP) 07 014 810.1-1236

(51) Int. Cl. G01M 1/14

(52) U.S. Cl. 73/459

(57) ABSTRACT

A method of balancing a vehicle wheel in which to calculate the respective balancing masses permissible mass deviations (tolerances) for dynamic balancing are greater than the permissible mass deviation (tolerance) for static balancing. The measuring run is stopped when the calculated balancing masses lie within the predetermined tolerances (FIGURE).

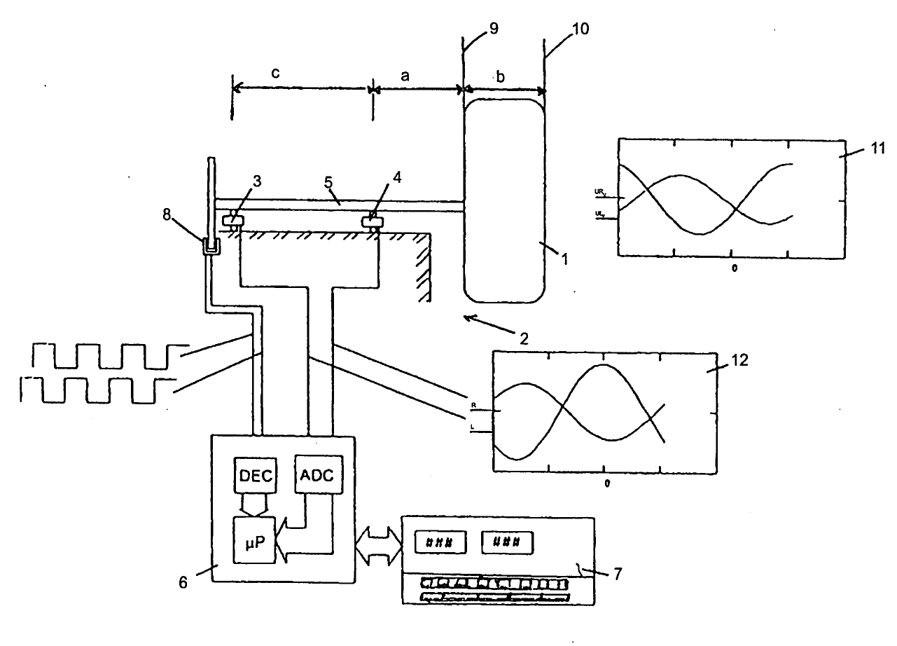

The invention concerns a method of balancing a vehicle wheel.

It is known from U.S. Pat. No. 4,854,168 to measure forces resulting from a wheel unbalance in a measuring run on the vehicle wheel as it rotates. The measured forces are used as the basis for the calculation of balancing masses which are available in predetermined mass stages, for example of 5 g, in associated rotary angle positions, in two balancing planes on the vehicle wheel, which are perpendicular to the axis of the wheel, to provide for dynamic balancing. In addition, a static unbalance vector is determined therefrom by vector addition. Balancing in the two balancing planes is effected in such a way that the static residual unbalance is minimised. That avoids vibration which essentially results from the static residual unbalance and which makes itself apparent when driving the motor vehicle in the form of judder through the steering. In the majority of cases weights are used for the balancing operation in such a number and size which in practice are not necessary for adequate quality of balancing.

The object of the invention is to provide a method of the kind set forth in the opening part of this specification, in which balancing on the vehicle wheel is achieved with sufficient quality in terms of travel performance.

That object is attained by the features of claim 1 while advantageous developments of the invention are set forth in the appendant claims.

The invention provides that the forces resulting from a wheel unbalance are measured in a measuring run on the rotating vehicle wheel. Respective balancing masses available in predetermined mass stages are calculated in associated rotary angle positions about the wheel axis from the measured forces for dynamic balancing in two balancing planes which are perpendicular to the wheel axis and also for static balancing in a balancing plane on the vehicle wheel. The balancing masses can be available in 5 g mass stages or a multiple of 5 g, in conventional manner.

When calculating the respective balancing mass, the permissible mass deviation (tolerance) from the respective exact balancing mass corresponding to the measured forces, for dynamic balancing, is greater than the permissible mass deviation (tolerance) for static balancing. The respectively calculated balancing mass is fixed to the vehicle wheel in the form of a balancing weight at the associated angular position and in the associated balancing plane.

The mass deviation for dynamic balancing can be at least twice as great as the mass deviation for static balancing. By way of example the mass deviation for static balancing can be 5 g and the mass deviation for dynamic balancing can be for example from 10 g to 30 g. The magnitude of the mass deviation can depend on the type of vehicle. By way of example, for sports utility vehicles or SUVs or motor caravans and the like the mass deviation can be 1.5 times the mass deviation which is permissible for private motor cars or motorcycles. For light goods vehicles the mass deviation can be about twice that which is permissible for private motor cars and motorcycles.

If, in calculation of the balancing mass, it is found that the balancing masses calculated for dynamic balancing are within the associated tolerance, the computing equipment (computer) preferably automatically switches over to calculating the balancing mass and the associated rotary angle for static balancing. That calculation preferably involves taking account of the fact that the vehicle wheel is also balanced within the tolerance which is predetermined for dynamic balancing.

If the vehicle wheel is dynamically balanced that balancing procedure is effected in such a way that the static balancing is also effected within the tolerance prescribed for same.

Balancing is unnecessary if both the balancing mass calculated for dynamic balancing and also the balancing mass calculated for static balancing respectively lie within the predetermined tolerances. In that case stepwise changes in the angular positions of the respective balancing masses for dynamic balancing and also for static balancing can be implemented to determine the resulting balancing masses and the balancing operation which is to be implemented entails using the calculated balancing masses which are within the predetermined tolerances for dynamic and static balancing and in respect of which the total of the balancing masses is the lowest. The corresponding balancing weights are then fixed to the vehicle wheel in the corresponding balancing planes and at the associated rotary angle positions which were ascertained in the calculation procedure.

Besides the saving on balancing weights, the invention can also provide for a curtailment of the measuring run time. For that purpose, at least two revolutions are implemented at the measuring rotary speed in the measuring run, with the respective balancing masses and associated rotary angle positions being calculated in that situation. The measuring run is stopped when the balancing masses which are calculated in the following revolutions remain within the predetermined tolerances. In that case the balancing masses calculated in the respective revolutions can be used to calculate the respectively resulting average value. As soon as those average values also remain within the predetermined tolerances in the subsequent rotary movement the measuring run is interrupted.

The invention is described in greater detail hereinafter with reference to the FIGURE.

The FIGURE diagrammatically shows a measuring arrangement of a wheel balancing machine 2. The measuring arrangement includes force transducers 3, 4 which are supported at a measuring shaft 5 of the wheel balancing machine 2. A vehicle wheel 1, in particular a motor vehicle wheel, is fixed in centered relationship on the measuring shaft 5 in known manner. Connected to the measuring shaft 5 is an angle sensor 8 which detects the respective rotary angle of the vehicle wheel 1 and passes a corresponding electrical signal which contains the respective angular increments to an evaluation device 6. The electrical sinusoidal force fluctuation signals L and R which are generated by the force transducers 3 and 4 and which are supplied by the left-hand force transducer 3 and the right-hand force transducer 4 are shown in the graph configuration 12 in the FIGURE in relation to the rotary angle θ measured by the angle sensor 8. Those force fluctuation signals L and R are passed to the evaluation device 6.

The rotary angle signals of the angle sensor 8 are passed in the evaluation device 6 by way of a decoder DEC to the electronic computing equipment μP. The force fluctuation signals L and R of the force transducers 3 and 4 are passed by way of an analog/digital coder ADC to the electronic computer μP in the evaluation device 6. In addition the geometry data of the measuring device and the vehicle wheel 1 which is to be balanced are inputted into the electronic computer μP. This involves the spacing b of balancing planes 9 and 10 in which balancing weights which are to be calculated are fitted. Furthermore the radii at which the balancing weights are fitted in the balancing planes 9 and 10 are also inputted into the electronic computer of the evaluation device 6 for the calculation procedure. Moreover the spacings a and c are taken into consideration in the computing operation in the electronic computer in the evaluation device 6. The spacing c is the fixedly predetermined spacing of the measuring transducers 3 and 4 from each other while the spacing a is the spacing of the inwardly disposed balancing plane 9 from the outwardly disposed (right-hand) measuring transducer 4.

Having regard to the geometry data associated with the respective vehicle wheel sinusoidal fluctuation signals U_{L} and U_{R} for balancing masses are calculated, with respect to the rotary angle θ, from the two sinusoidal force fluctuation signals L and R for the two balancing planes 9 and 10. The respective maxima of those fluctuation signals correspond to balancing masses which, when arranged at the associated rotary angle positions in the respective balancing plane 9 and 10, cause exact dynamic balancing and correspond to balancing vectors [symbol] in the left-hand (inner) balancing plane and [symbol] in the right-hand (outer) balancing plane.

The balancing planes [symbol] and [symbol] are calculated from the following system of equations:

$${L}^{ρ} = \frac{{{U}^{μ}}_{L} a + {{U}^{μ}}_{R} ( a + b )}{c}$$

$${R}^{ρ} = \frac{{{U}^{μ}}_{L} ( a + c ) + {{U}^{μ}}_{R} ( a + b + c )}{c}$$

The balancing masses which result from the respective maxima of the fluctuation signals shown in the graphic representation 11 in respect of the balancing masses, in the associated rotary angle positions, represent pure dynamic balancing vectors [symbol] and [symbol] . A purely static balancing vector [symbol] is calculated therefrom, which also corresponds to a balancing mass arranged in a given rotary angle position in a balancing plane, from the following system of equations:

$${{U}^{ρ}}_{L} = \frac{{U}_{S}^{μ}}{2} + {{U}^{ρ}}_{DL} , {{U}^{ρ}}_{R} = \frac{{U}_{S}^{μ}}{2} + {{U}^{ρ}}_{DR}$$

Therein [symbol] denotes the purely static vector component which includes the purely static balancing mass U_{S} and the associated rotary angle position in a balancing plane in which static balancing occurs.

Therein [symbol] denotes the balancing vector which includes the balancing mass U_{DL} and the associated rotary angle position in the left-hand (inner) balancing plane 9.

[symbol] denotes the balancing vector in the outer (right-hand) balancing plane 10 which includes the balancing mass U_{DL} and the associated rotary angle position in the outer (right-hand) balancing plane.

Different permissible mass deviations (tolerances) are predetermined for the balancing procedure, in respect of the purely static balancing mass and in respect of the two purely dynamic balancing masses. In that respect the permissible mass deviation (tolerance) in respect of the static balancing mass U_{S} is less than that in respect of the two dynamic balancing masses U_{DL} and U_{DR}. The permissible mass deviations (tolerances) for the calculated, purely dynamic balancing masses U_{DL} and U_{DR} are preferably at least greater by two times than the permissible mass deviation (tolerance) for the calculated, purely static balancing mass U_{S}. The permissible mass deviation in respect of the purely static balancing mass can be for example 5 g while the permissible mass deviation in respect of the two purely dynamic balancing masses can be 10 g or more, in particular from 10 g to 30 g.

The mass of the smallest mass stage, for example 5 g, which is available for the balancing procedure, or an integral multiple thereof, can be determined for the mass deviation. For example the tolerances for the purely static balancing mass and the purely dynamic balancing masses can be inputted into the computer μP of the evaluation device 6 by means of a keyboard on a display and input arrangement 7, or other input means.

In the calculation of the balancing masses for dynamic balancing, the angular positions for the balancing masses in the two balancing planes are altered stepwise for example in steps of 10 degrees and the resulting dynamic balancing masses and the resulting static balancing masses are respectively determined on the basis of the two sinusoidal fluctuation signals [symbol] and [symbol] (signal representation 11 in the FIGURE). The balancing masses in respect of which the tolerances are observed and the total of the balancing masses is the smallest are used for dynamic balancing. For calculating purely static balancing which is preferably effected automatically when the initially calculated balancing masses for dynamic balancing are within the tolerances, firstly the appropriate balancing plane in which static balancing is to be effected is selected. Preferably in that respect the plane in which the calculated greater dynamic balancing mass occurs is selected. For determining the static balancing mass which is in that balancing plane, the rotary angle position is altered until, on the basis of the fluctuation signals [symbol] [symbol] (sinusoidal signal representations at 11 in the FIGURE) the tolerances which are predetermined for dynamic and static balancing are attained or the values involved are below those tolerances.

The balancing masses which are calculated in respect of dynamic or static balancing are displayed in a display unit of the display and input arrangement 7. Suitably sized balancing weights are then fixed in the angular positions which are also displayed, in the two balancing planes 9 and 10 when dynamic balancing is involved and in one of the two balancing planes 9 and 10 when static balancing is involved.

As already explained hereinbefore the measuring run can be terminated if, during the wheel revolutions which take place in the measuring run, values which lie within the tolerances in respect of at least two successive revolutions are afforded for the static balancing mass and the dynamic balancing masses. That makes it possible to achieve a reduction in the measuring run duration, in comparison with known unbalance measuring run times.

1. A method of balancing a vehicle wheel wherein
forces resulting from a wheel unbalance are measured in a measuring run on the rotating vehicle wheel,
the measured forces are used as a basis for calculating respective balancing masses available in predetermined mass stages in given rotary angle positions about the wheel axis for dynamic balancing in two balancing planes which are perpendicular to the rotor axis and for static balancing in a balancing plane on the vehicle wheel, wherein
in the calculation of the respective balancing mass the permissible mass deviation (tolerance) from the respective exact balancing mass corresponding to the measured forces is greater for dynamic balancing than the permissible mass deviation (tolerance) for static balancing, and
a balancing weight corresponding to the respectively calculated balancing mass is fixed to the vehicle wheel in the associated angular position and the associated balancing plane.

2. A method according to claim 1 characterised in that the mass deviation for dynamic balancing is at least twice as great as the mass deviation for static balancing.

3. A method according to claim 1 or claim 2 characterised in that the mass deviation corresponds to the smallest mass stage available for balancing or an integral multiple thereof.

4. A method according to one of claims 1 to 3 characterised in that when the calculated balancing masses for dynamic balancing lie within the tolerance the procedure is automatically switched over to static balancing.

5. A method according to one of claims 1 to 4 characterised in that in static balancing dynamic balancing is simultaneously effected within the tolerance predetermined for same.

6. A method according to one of claims 1 to 4 characterised in that in dynamic balancing static balancing is simultaneously effected within the tolerance predetermined for same.

7. A method according to claim 5 characterised in that in the calculation of the balancing mass for static balancing the balancing plane in which the calculated greater balancing mass is disposed is selected and the rotary angle position for the balancing mass is altered stepwise until the tolerances which are predetermined for dynamic and static balancing are reached or the values involved are below said tolerances.

8. A method according to claim 6 characterised in that in calculation of the balancing masses in respect of dynamic balancing the angular positions for balancing in the two balancing planes are altered with simultaneous calculation of the static balancing mass from the respectively resulting dynamic balancing masses and the balancing masses which are ascertained in that case are used in the angular positions for dynamic balancing, at which the total of the balancing masses is at the lowest.

9. A method according to one of claims 1 to 8 characterised in that the measuring run is stopped when the balancing masses calculated from the measurement results of at least two successive revolutions of the wheel are within the predetermined tolerances.

10. A method according to claim 9 characterised in that average values of the balancing masses calculated during successive measuring runs are formed and the measuring run is terminated when the average values of the calculated balancing masses lie within the predetermined tolerances.
